(19) United States
(12) Patent Application Publication
(10) Pub. No.: US 2010/0023442 A1
(43) Pub. Date: Jan. 28, 2010

(54) SYSTEM, METHOD AND MEDIA FOR TRADING OF EVENT-LINKED DERIVATIVE INSTRUMENTS

(76) Inventors: Jeffrey K. O'Hara, Chicago, IL (US); Richard Sandor, Chicago, IL (US); Michael Walsh, Downers Grove, IL (US)

Correspondence Address: WINSTON & STRAWN LLP;PATENT DEPARTMENT, 1700 K STREET, N.W., WASHINGTON, DC, 20006, US

(21) Appl. No.: 12/509,044

(22) Filed: Jul. 24, 2009

Related U.S. Application Data
(60) Provisional application No. 61/083,865, filed on Jul. 25, 2008.

(51) Int. Cl. G06Q 40/00

(52) U.S. Cl. 705/37; 705/35

(57) ABSTRACT

A derivative financial instrument is created which facilitates the reallocation of a risk caused by the occurrence of an event or condition. For example, a system, method, and media are directed to allocating risks of water shortages. A computer-readable financial instrument is established based on a water availability score that is calculated from one or more types of hydrological factors, a settlement value function, and a settlement date. The financial instrument is configured to transfer, on the settlement date, a cash or physical commodity amount to a buyer or seller of the instrument as determined by the contract specification if the score is zero, or a positive or negative number or within a specified range of positive or negative values.

This application claims the benefit of U.S. provisional patent application No. 61/083,865 filed Jul. 25, 2008, the entire content of which is expressly incorporated herein by reference thereto.

### FIELD OF THE INVENTION

The present invention relates to a system, method and media for allocating a risk of the occurrence of an event or condition that may affect certain business or other interests, and more particularly, but not exclusively, to event-linked derivative financial instruments pertaining to water scarcity.

### BACKGROUND

Financial instruments can be created to address effects to businesses or other entities from the occurrence of specified future events or conditions. An instrument sold by one participant to another participant forms a contract that upon the future occurrence of the specified event or condition, a buyer or seller of the instrument would make a payment or deliver other resources and the other party would receive a payment or other resources.

Significant economic value is associated with water supply. As a matter of routine, industry, agriculture, governments, financial enterprises, fisheries, forestry, energy systems, and numerous other economic activities are dependent upon water supply. Entities within these sectors are exposed to considerable economic risk due to stochastic and variable water supply scenarios.

Water scarcity is a critical issue. Water is anticipated to become a scarcer and more valuable resource in the future. These stresses are attributable to both the nature of the hydrologic cycle and the characteristics of water as an economic good. Water, relative to other publicly provided goods such as electricity, is cheap to store and expensive to transport. Thus, water supply and distribution systems are designed to serve either local or regional areas. The hydrologic cycle dictates that evaporation in one area does not necessarily return as precipitation in the same area. Evaporation and precipitation are strongly influenced by local terrain, such as soil, vegetation, and wind patterns in a region.

In addition, the variability of water supply is great both within and between years. Precipitation can be strongly influenced by climate phenomena such as El Nino Southern Oscillation and the Pacific Decadal Oscillation. Storage is necessary as it allows the transfer of water from periods when supplies are high to periods when demands are high. This problem is exacerbated because demand on water supplies is higher during periods when supplies are likely to be low, since users must resort to supplied water to replace amounts normally obtained naturally from precipitation.

Low water levels have considerable economic consequences. Examples of these include an inability for ships to stow and transport sufficient cargo; insufficient water for irrigation, hydropower production or municipal water supplies; and an inability of industrial users to engage in production. Costs also include economic or environmental damages associated either with insufficient water or means by which water supply may be augmented (i.e., building another reservoir).

Finally, inefficiencies exist with respect to water regulation and distribution. First, individuals or entities who attach less value to the water may have the most senior rights and may further be prevented through regulation from transferring or selling the water to those with higher valuations. Secondly, water pricing and rationing are frequently set at suboptimal levels that do not lead to the efficient use of the resource. Typical practice for water pricing by water districts is to charge rates equal to the average cost of the historical distribution facilities, which price bears no relationship to the market price for water determined by supply and demand.

Thus, a situation exists whereby shortages may arise in particular regions where supply cannot be effectively augmented due to a lack of precipitation, capacity constraints, and inefficient regulation. These conditions can persist in a series of dry years which may cause extreme hardship and substantially increase the costs of water-dependent activities. Climate change impacts on the hydrologic cycle will lead to altered intensity and frequency of precipitation, increased evaporation, and a loss of snow pack in regions where it acts as a natural reservoir. These impacts may be greatest in areas where water systems are already exhibiting extreme stresses.

An example of such a scenario would be a water shortage in a region that relies intensively on water for agriculture and energy production. Water shortages would not only impose considerable economic costs on those sectors, but also on public and financial sectors that have relationships with these sectors. Currently, there is no suitable and focused financial instrument that allows a party to hedge against or transfer the risks associated with such water shortages from those entities that face these risks to those entities that are willing to accept the risks. The present invention provides such a mechanism and meets this need.

### SUMMARY OF THE INVENTION

The invention relates to a computer-implemented method for creating an event-linked derivative financial instrument, which comprises identifying an event or condition that affects business or other interests; identifying one or more factors that are indicative of the event or condition occurring; determining a methodology for using one or more factors to derive a score that indicates the event or condition is occurring or the extent to which it has occurred; determining another methodology that calculates an amount of money or resources to be delivered at settlement of the financial instrument based on the score or derived from a score or scores; providing a means for determining the market value and trading of the financial instrument; and creating a settlement value function for the financial instrument based on the methodologies. A single factor could be used to determine a score without any further manipulation.

An embodiment of the invention is a computer-implemented method for allocating a risk of a water shortage, which comprises establishing a computer-readable financial instrument based on a score determined from factors such as the occurrence of certain weather conditions and the measure of water resources present in a particular geographic region, a marketplace where such an instrument could be bought and sold, a settlement value function, and a settlement date, wherein the financial instrument is configured to transfer on the settlement date, a cash payment or transfer of other resources to a party based on a score that reflects the extent to which an event or condition has occurred. The instrument could be an exchange-traded derivative instrument contract with standard terms or an over-the-counter traded derivative instrument wherein the buyer and seller have negotiated and agreed on terms that are unique to the instrument. Depending on the contract specification for settlement of the instrument, a cash payment or transfer of other resources could be required of the buyer or seller if the score is zero, or is in a specified range of positive or negative values. The score or some derivation of multiple scores could also be multiplied by a financial factor to yield a dollar amount that would be paid upon settlement.

The score derived for an instrument relating to water supply is advantageously an indicator of water availability that is calculated from one or more types of hydrological factors, so that the method further comprises determining the hydrological factor(s) that are indicative of available water supply for a geographic region (as well as calculating the score from the determined hydrological factors). Such factor(s) could include an aquifer level, a snow-pack level, a stream-flow measurement, an above-ground body of water level, a weather measure, a predictive weather measure, a value representing a climate variable, or a precipitation level. The invention may further comprise providing an interface to present the financial instrument to a user with an economic interest in the occurrence of the event or condition within a geographic region. The method can further comprise providing for trading of the financial instrument within some type of marketplace. The value of the score at the time of the trade is information that will be used by traders to formulate bids and offers. There are other considerations that market participants may perceive as relevant as they make bids and offers, such as time to expiration, carrying costs and information about the likelihood of the occurrence of the subject event or condition (that is not incorporated in the score).

A party could eliminate some or all of its rights and/or obligations arising in connection with being a buyer or a seller of such a financial instrument, by transferring its rights or obligations, or taking a corresponding position in a separate trade on an exchange or in an over-the-counter transaction. For example, a participant that has entered into a contract to sell an instrument could enter into a subsequent trade to buy the same type of instrument, thereby offsetting some or all of its obligations arising from the first trade by undertaking separate but corresponding obligations in the second trade. If the value of the instrument at the time of the first trade is different from the value at the time of the second trade, the party may make or lose money because the amount of money exchanged in the two trades would also be different.

In addition to valuing a financial instrument using the score value, the method can also include determining the value based on change of the score, an average change of the score over a time period, a value of the score on a date less a threshold value configured in the financial instrument, or, when the score has more than one portion, a weighted sum of the score portions. The financial instrument is at least one of a spot contract, forward contract, futures contract, options contract, swap contract or other derivative instrument.

The method may further include allowing the participants to trade such instruments by depositing an amount that is less than the full agreed price (“margin”), determining such margin amount for an account of a party participating in a trade of the financial instrument based in part on the value of the score on the date of the trade, and adjusting the margin amount during the time before the instrument is settled based on variations in the score. Ultimately, some or all of the margin amount may be transferred as part of settlement of the financial instrument.

Another aspect of the invention relates to a system for allocating a risk of a water shortage, comprising at least one processor, wherein the at least one processor is configured to perform the method steps described herein.

Yet another aspect of the invention relates to a processor-readable medium for allocating a risk of a water shortage based on a water availability score that is calculated from one or more types of hydrological factors; a settlement value function; and a settlement date. The processor-readable medium further comprises instructions that are executed by a processor to perform actions which may comprise transferring on the settlement date, an amount of cash or other resources to a buyer or seller in settlement of the instrument based on the settlement value function using the score.

### BRIEF DESCRIPTION OF THE DRAWINGS

FIG. 1 shows a logical flow diagram for creating an event-linked derivative financial instrument.

FIG. 2 shows a logical flow diagram for hedging against risks using an event-linked derivative financial instrument.

FIG. 3 shows an example of a logical flow diagram for using a financial instrument (futures contract) for hedging against water shortages, including the process for valuation prior to expiration.

FIG. 4 illustrates another example of a logical flow diagram for using a financial instrument (futures contract) for hedging against water shortages, including the process for settlement.

FIG. 5 shows an example of a logical flow diagram for using factors to determine a score that is used to value a financial instrument relating to water supply.

FIG. 6 shows an example of a logical flow diagram for using factors to determine a cash settlement amount for a derivative financial instrument on a settlement date.

FIG. 7 shows a method and system for allocating a risk of a water shortage.

### DETAILED DESCRIPTION OF THE INVENTION

As used herein, the term “derivative instrument” or “derivative financial instrument” refers to any financial instrument, the value of which is based on some other financial instrument or variable. The derivative financial instrument may be settled in cash or the physical commodity.

The terms “financial instrument” and “instrument” are generally used as a short form reference for derivative financial instrument.

An “event-linked” financial instrument is one in which its market value and settlement value are based on the occurrence of an event or condition.

The term “event or condition” refers to the specified event or condition that may affect a business or other interest, for which a financial instrument may be created as a hedging tool.

The term “factor” refers to a measurable indicator of an event or condition occurring, that it is in the process of occurring or that it has occurred. A factor can be a score if the score is derived using only a single factor.

The term “score” refers the number, yes/no outcome, or other value determined from a formula using data representative of a number of factors.

The term “financial factor” refers to a factor applied to a score to convert it to monetary expression.

The term “settlement” refers to the process of satisfying all rights and obligations of parties to a financial instrument contract at the expiration date, in accordance with the specifications for the financial instrument.

The term “settlement value function” refers to any mathematical or conditional (e.g., if . . . then . . . ) function for computing an output value from at least one input value. The settlement value function may be linear, non-linear, continuous, non-continuous, step-wise, or any other type of function.

Generally, the present invention relates to a computer-implemented system, method and media for allocating risks from the occurrence of an event or condition that may affect business or other interests. It may be used for example, in the case of addressing water shortages. The method includes identifying a geographic region and interest that is vulnerable to the occurrence of the event or condition, identifying one or more metrics or factors (hereinafter “factors”) that are indicative of the extent to which the event or condition has occurred in the specified geographic region, using the factor(s) to create a score to be used in connection with determining the pre-expiration value and settlement value of a financial instrument, and allowing parties affected by the occurrence of the event or condition to trade the instrument, with the societal benefit of such systems being the ability to transfer risks from those who wish to reduce economic exposure from the occurrence of the event or condition to those who can and will absorb such exposure. Water scarcity is an example of an event or condition that can affect business or other interests.

A water derivative instrument such as a futures contract according to the invention could be designed to hedge against scarcity and would have great value. First, it provides entities exposed to this risk an opportunity to hedge against possible increased costs. Secondly, the contract price offers a clear signal of the economic costs associated with water shortages. This price can have important policy implications as it provides a previously unavailable monetary indication of the value of water.

One embodiment of the invention more specifically relates to a computer-implemented method for allocating a risk of the occurrence of an event or condition such as water shortage, which comprises establishing a computer-readable financial instrument based on a score that is calculated from one or more types of (hydrological) factor measures, a settlement value function, and a settlement date. The financial instrument may be configured to transfer, on the settlement date, a cash payment or other resources to a buyer or seller of the instrument based on the value of the score. The instrument could be structured so that the settlement value is calculated based on the score or derived from a score or scores, or alternatively so that a specified amount of money or resources is delivered if the score achieves certain values. A participant might experience a gain or loss on a subsequent trade depending on whether the value of the instrument varies from the initial trade price. The instrument could be an exchanged traded derivative instrument contract with standard terms or an over-the-counter traded derivative instrument wherein the buyer and seller negotiate terms that are unique to the instrument. Depending on the specification for settlement of the instrument, a cash payment or transfer of other resources to buyer or seller could be required if the score is a positive, negative or zero value, or within a specified range of values. The method generally includes providing a trade of the financial instrument, and further allowing parties to undertake an offsetting position in the same or similar instrument, whereby such party would realize a gain or loss equal to the difference between the amount paid and the amount received. It is also possible that the specific instrument that is the subject of the initial trade could be transferred back to the original counterparty or to a third party. The financial instrument may be at least one of a spot contract, forward contract, futures contract, options contract, swap contract or other derivative instrument contract.

In one embodiment of the invention, the method further comprises determining one or more hydrological factors for a geographic region; and calculating a score from the determined hydrological factor(s). The establishing further comprises providing an interface to present the financial instrument to a user with an economic interest in a water shortage risk in a geographic region. The types of hydrological factor measures could include an aquifer level, a snow-pack level, a stream-flow measurement, an above-ground body of water level, a weather measure, a predictive weather measure, a value representing a climate variable, or a precipitation level.

The providing of the trade of the financial instrument can further comprise receiving a value of the score at the time of considering a trade and determining a price for the trade based on bids and offers for the financial instrument, representing the score as adjusted by buyers' and sellers' perception of other information concerning the likelihood that the event or condition will occur to some extent in the future, including such information as the cost to carry the instrument and the length of time until expiration of the instrument. The market value of the financial instrument may change if there is a change in the value of the score, but since the market price of an instrument often reflects considerations other than the score, it is unlikely that it will be a direct correlation between score and price.

The method can include determining the settlement amount based on at least one of the score, a change of the score, an average change of the score over a time period, a value of the score on the settlement date less a threshold value configured in the financial instrument, or, when a score has more than one portion, a weighted sum of the score portions. Depending on the contract specification for settlement of the instrument, a cash payment or transfer of other resources to buyer or seller could be required if the score is zero, or is in a specified range of positive or negative values. The score (or other score derived value) could also be converted using a financial factor to yield a dollar amount that would be paid upon settlement.

The method may further comprise allowing a the participants to trade such instruments by depositing an amount that is less than the agreed price (“margin”), determining such margin amount for an account of a party participating in a trade of the financial instrument based in part on a value of the score on a date of the trade, and adjusting the margin amount during the time before the instrument is settled based on variations in the score. Ultimately, some or all of the margin amount may be transferred as part of payment for settling the financial instrument.

As noted above, one embodiment of the method includes a system for allocating a risk of a water shortage, comprising at least one processor, wherein the at least one processor is configured to perform the steps of the method. The system is responsive to a processor-readable medium.

In another embodiment, the method provides compensation to an entity against a shortfall of water necessary for an operation of the entity, by establishing a financial instrument based on a water availability score that is calculated from the measure(s) of one or more types of hydrological factors as disclosed herein, a settlement value function, and a settlement date; receiving a right to the established financial instrument; and receiving an amount of money or other resources at settlement depending upon the calculation of the score, if the entity still holds the right to the financial instrument on the settlement date. This method can also include determining the settlement amount based on a weighted sum of a weight function applied to each portion of the score, if the score has more than one portion. In one embodiment, the score could be converted to a pecuniary amount by use of a financial factor.

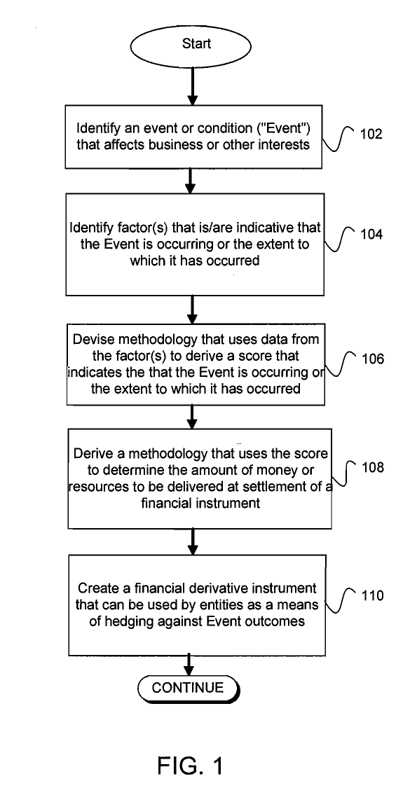

FIG. 1 shows an example of a logical flow diagram for creating an event-linked derivative financial instrument.

At step 102, an event or condition that affects business or other interests may be identified. A the hedged risk may be involve increased expenses or a loss of revenue, net income, profitability, reputation, or the like. The significant detriment may be at least a 5% increase in expenses or decrease of revenue, net income, profitability, or the like. The event or condition may be any commercial, governmental and/or environmental event or condition external to the business or other interest. For example, for an agricultural business, the weather is external to the farm's income stream or production. In this example, new legislation concerning a subject of interest to farmers may be used as the event or condition.

At step 104, at least one factor that is indicative of the event or condition occurring or the extent to which it has occurred is identified. In one embodiment, the factor may be any measurable quantity or quality associated with the event or condition. For example, for a certain type of weather event or condition, temperature, water saturation, historic precipitation levels, or the like may be identified.

At step 106, a methodology is determined, such that the methodology uses the data from the at least one factor to derive a score that indicates the extent to which an event or condition has occurred. In one embodiment, the methodology may be the use of a conditional probability, a table, a learning model, a neural network, an expert system, or any other system for predicting an output based on an input. The methodology may be determined dynamically by training a neural network, by using learning methods, online training methods, or the like.

At step 108, another methodology is determined, such that the other methodology uses a financial factor to convert the score to determine an amount of money or other resources to be delivered at settlement of a financial instrument. Similar to the methodology of step 106, the other methodology may also be determined.

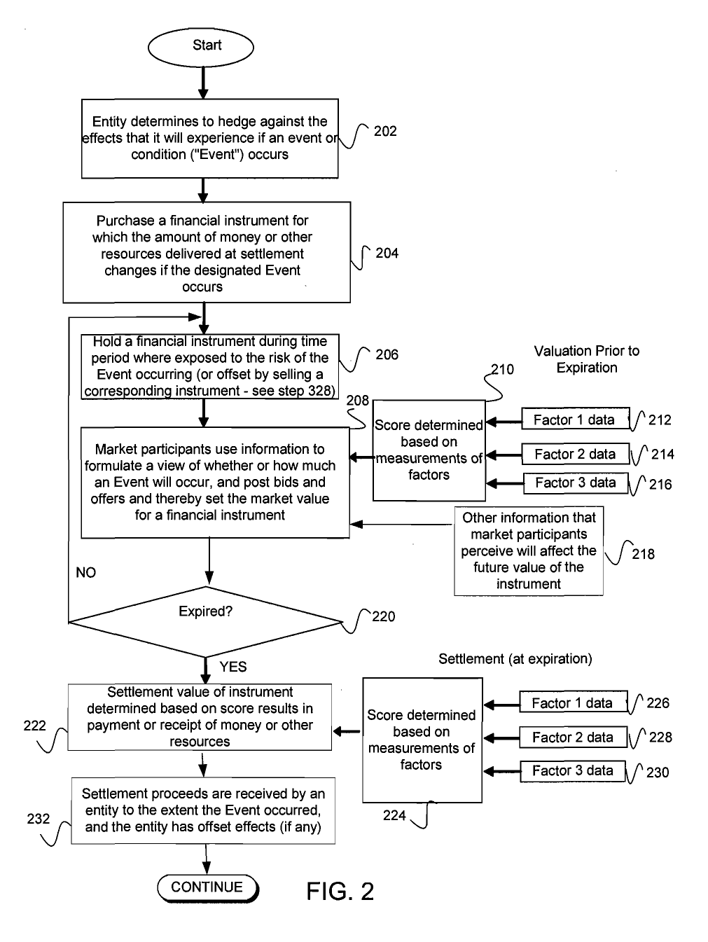

At step 110, a financial instrument is created that entitles the buyer to receive an amount of money or other resources on a future date, depending on the extent to which the event or condition has occurred. The financial instrument may be a tradable instrument. In one embodiment, a settlement value function for the financial instrument may be created based on methodologies. The financial instrument may be provided for trading. For example, the financial instrument may be used, as shown in FIGS. 2-7, to minimize the impact of the event or condition occurring.

FIG. 2 shows a logical flow diagram for the use of an event-linked derivative financial instrument for hedging against risks. In general, FIG. 2 shows an example of how a derivative financial instrument may have an adjustable settlement price based on a factor achieving a certain level, or by using multiple factors to derive a score that can be converted to a financial expression to be used for settlement.

At step 202, an entity may determine to hedge against the effects that it will experience if an event or condition occurs. The hedge provided by the instrument may be any outcome that reduces, offsets or cancels the effects associated with occurrence of the event or condition. The occurrence of an event or condition may have local or worldwide impact, and correspondingly be indicated by factors present in a limited geographic area or in anywhere in the world.

At step 204, a purchase is received, where the purchase is of a financial instrument with a settlement that changes in monetary value or other deliverable if the designated event or condition occurs. The purchase may be received over a network, a computer trading system, or the like.

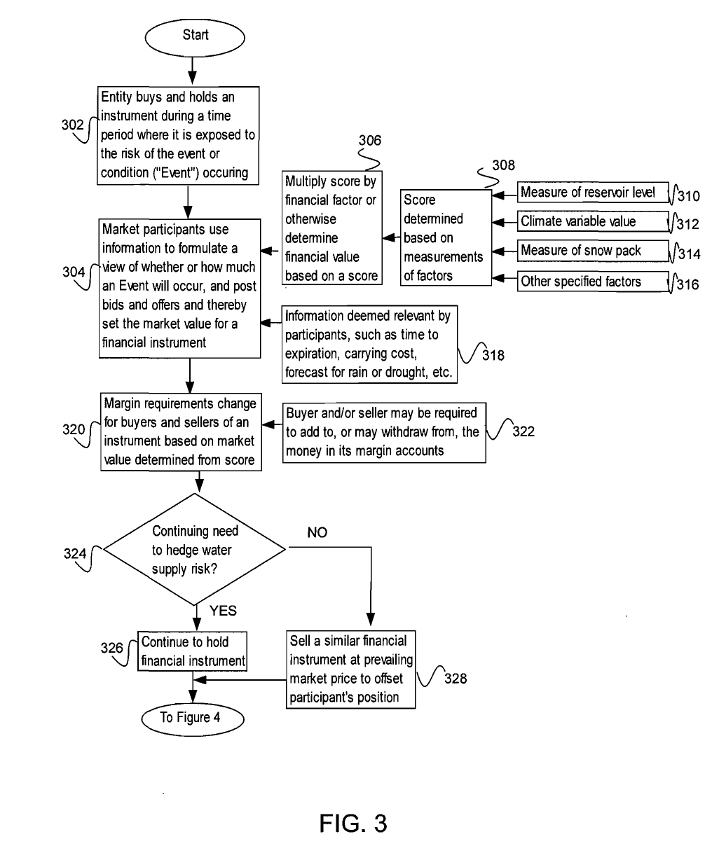

At step 206, the instrument is held during the time period where the entity is exposed to the risk of the event or condition occurring. In one embodiment, the instrument may be held by the entity, but in another embodiment, the rights or obligations associated with an instrument may be transferred by further trading the instrument, or offset by taking the opposite position in a second trade of the same type or a similar instrument (e.g., see FIG. 3, steps 324, 326 and 328).

At step 208, the market value of the instrument before expiration may vary based on market participants' views of the likelihood of the event or condition occurring. In one embodiment, the value may be determined as a function of a score or scores, and other information. The settlement value function may be established in a contract specification or otherwise established for the financial instrument. In one embodiment, the score may be determined at step 210 based on measurable factors. In one embodiment, the factors may be determined at steps 212-216. Other information perceived to be relevant to the future value of an instrument is determined at step 218.

At decision step 220, it is determined whether the instrument has expired. In one embodiment the instrument expires after the passage of a period of time or on a date specified for the instrument. In another embodiment the instrument is specified to expire upon the occurrence of an event or condition. The determination may be made by a government entity, a regulatory body, an institution, or some other entity. If the instrument has expired, processing continues to step 222. Otherwise, processing loops back to step 206.

At step 222, the instrument is settled based on a settlement value function. In one embodiment, the settlement value may be determined as a function of a score or scores. The settlement value function may be established in a contract specification or otherwise specified in the financial instrument. In one embodiment, the score may be determined at step 224 based on measurable factors. In one embodiment, the factors may be determined at determination steps 226-230.

At step 232, the entity may experience increased costs or other detriment due to the occurrence of an event or condition. In one embodiment, the holder of the instrument (e.g., the Entity) may receive a settlement in money or other resources for the financial instrument, thereby mitigating the increased costs or other detriment.

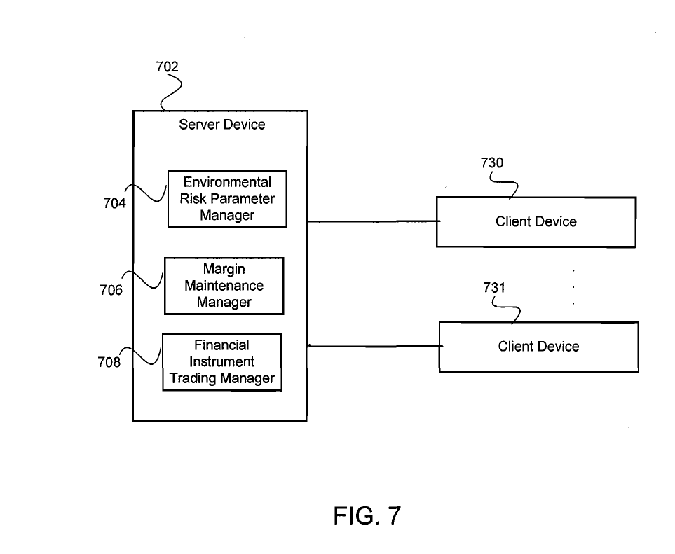

FIG. 3 shows an example of a logical flow diagram for using a financial instrument for hedging against a water shortage, including the process of valuation prior to expiration, according to one embodiment. In one embodiment, the hydrological factors may be determined by an environmental risk factor manager 704 of FIG. 7, using a user interface, a selection mechanism, or the like. The process of FIG. 3 may be performed by server device 702 and/or client devices 730-731 of FIG. 7.

At step 302, an entity with exposure to adverse consequences in the event of a water shortage buys and holds a financial instrument that provides for a cash payment to the extent of a water shortage.

At step 304, the market value of the instrument may be determined prior to its expiration from participants' bids and offers based on their views of the likelihood of a water shortage. In one embodiment, the bids and offers of participants may be determined by making reference to a score or scores determined from factors, and adjusting the score(s) by such other information as market participants believe is relevant. Accordingly, a score may be determined at step 308 based on factors measured at that point in time. The score may be stored in a database, associated with at least one financial instrument, published in a source (e.g., website), or the like. In one embodiment, calculating may include determining the hydrological factors for a geographic region and/or calculating the score from the determined hydrological factors. Preferably, at least 2 to 4 of these factors are calculated for more accurate results. The specific factors selected may vary depending upon the region and the specific factors that can be measured. In step 306, the score may be multiplied by a financial factor to express it in pecuniary terms.

In one embodiment, the factors used to determine the score, may be reservoir level, climate variables, snow pack and other factors noted at steps 310-316. Other information perceived by market participants to be relevant to the future value of the instrument, such as time to expiration, carrying costs and weather forecasts are determined at step 318.

At step 320, FIG. 3 describes the functionality of one embodiment of the invention wherein participants can trade instruments by payment of less than the full value (“margin”) of instruments. In this embodiment, the amount of margin to be deposited by the participants is determined by the score as determined in step 308. In step 322, buyers and/or sellers may be required to add money to, or may be able to withdraw money from, margin accounts.

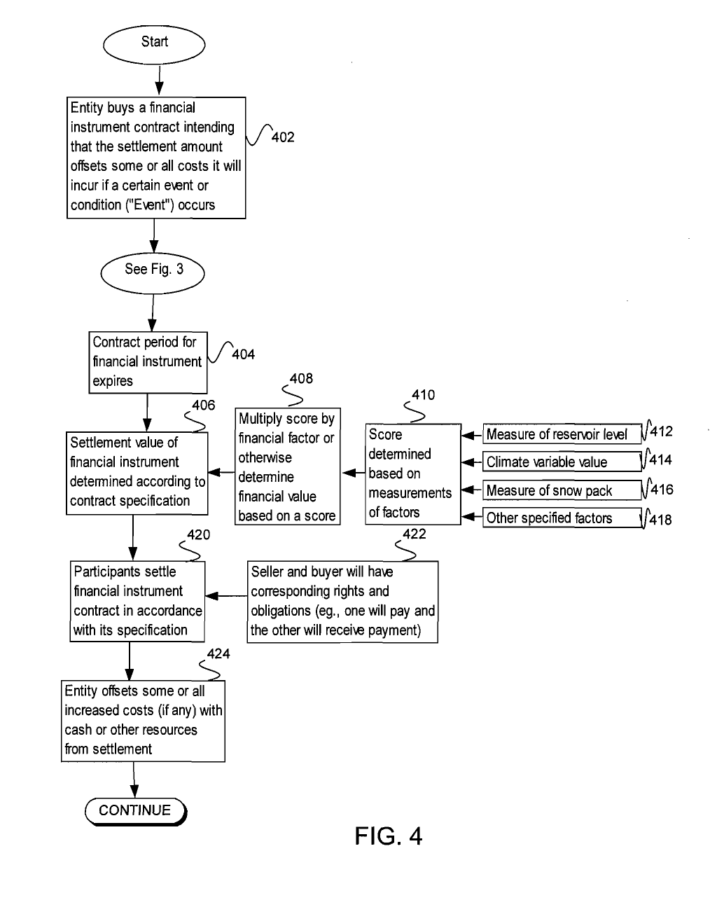

At step 324, an entity that owns an instrument may evaluate whether it is appropriate to continue to hedge the risk of the occurrence of an event or condition. At step 326, the entity opts to continue to hedge risks. At step 328, an entity that decides hedging is no longer necessary can sell the same type of instrument or similar instrument, thereby offsetting the rights and/or obligations of the hedge instrument. An alternate embodiment might allow a participant to transfer the subject instrument back to the original counterparty or to a third party. If an entity determines to maintain a hedged position, the instrument will ultimately settle as described in FIG. 4.

FIG. 4 shows an example of a logical flow diagram for using a financial instrument for hedging against water shortage, including the process of settlement, according to one embodiment. The process of FIG. 4 may be performed by server device 702 and/or client devices 730-731 of FIG. 7. At step 402, an entity buys a financial instrument to hedge against increased costs due to water shortage. The entity holds the instrument for the period prior to expiration as described in FIG. 3.

At step 404, the instrument expires in accordance with the requirements stated in the contract specification for the instrument or otherwise specified in connection with the instrument. In one embodiment, expiration can occur on a date in time or due to the passage of a period of time. In another embodiment, expiration could occur to the extent the event or condition occurred.

At step 406, the settlement value of the instrument may be determined based on a score or scores determined from factors. Accordingly, a score may be determined at step 410 based on factors measured at the specified time of expiration. In one embodiment, the factors used to determine the score, may be reservoir level, climate variables, snow pack and other factors noted at steps 412-418. In step 408, the score may be multiplied by a financial factor to express it in pecuniary terms.

In step 420, participants settle their respective obligations in accordance with the requirements stated in the contract specification or as otherwise specified in connection the instrument. Step 422 shows one embodiment of settlement involving payment of cash by one participant and receipt of cash by another participant. In another embodiment, a participant may be required to deliver an amount of a physical commodity to a particular place, and the other participant would receive such physical commodity if it had not transferred its rights or entered into an offsetting transaction with a third party.

In step 424, the entity that bought the instrument may be able to offset increases to costs experienced to the extent an event or condition occurred.

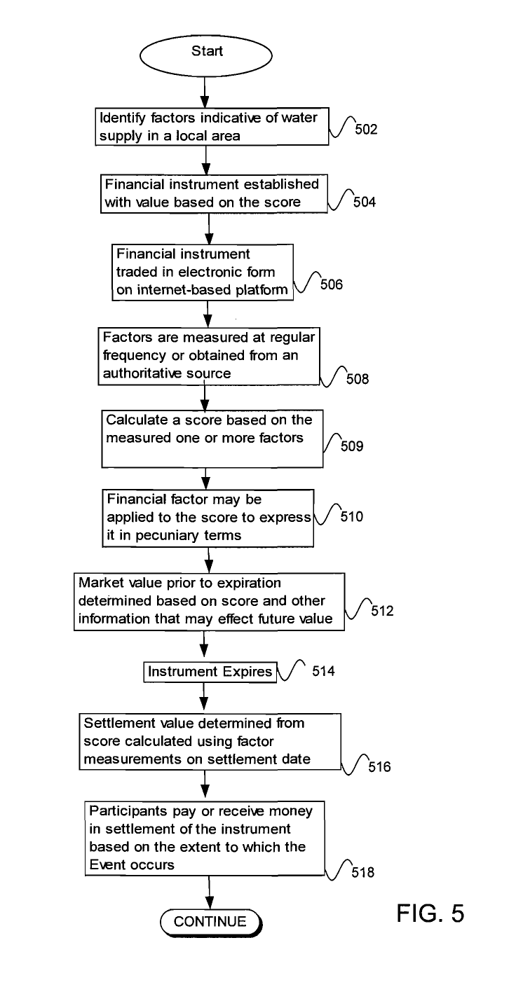

FIG. 5 shows an example of a logical flow diagram for using measurable factors to determine a score that is used to value a financial instrument relating to water supply. At step 502, factors indicative of water supply in a local area are determined. In one embodiment, the water factor metric determined in a geographic region relates to one or more, but is not limited to, the following possible factors: snow pack levels; reservoir levels; stream flow measurements; basin or lake levels; characteristics indicative of climatic fluctuations (such as El Nino Southern Oscillation or Pacific Decadal Oscillation); measurements at water pumping or distribution stations; a composite index calculated by a governmental agency or other organization; aquifer or well levels; precipitation levels; or a function of a combination of these factors. In some embodiments, the factor may have a quantifiable dimension that can be specified unambiguously. In other cases the value taken to represent the measure of the factor may be a “yes” or “no” value. By using multiple factors and weighting them appropriately in the score calculation methodology, it may be possible to achieve a more accurate representation of the water supply in a geographic region. Examples of methods by which these factor values are converted into a score and then into a monetary value (or if just one factor, converted directly into a monetary value) to determine a value for hedging purposes are described below.

At step 504, a derivative financial instrument is established based on a water availability factor or score, settlement value function, and a settlement date. The financial instrument may be established as described above in conjunction with step 110 of FIG. 1. In one embodiment, the entity purchasing the financial instrument may receive a right to receive, own, or otherwise control the commodity underlying the established financial instrument if certain events or conditions occur. In one embodiment, a specification for the financial instrument may be sent between client devices 730-731 and server device 702. The financial instrument may be established by environmental risk factor manager 704 of FIG. 7 stored in a database or the like.

The instrument may use various approaches to determining its value prior to expiration, a settlement value on the settlement date. In one embodiment, the derivative financial instrument may be established based upon the factor(s) that are used to derive a score that is indicative of the available water supply in a local area. In one embodiment, the instrument is in electronic form and is tradable. The traded instrument typically would have a market value based on various information including quantifiable hydrologic factors and a methodology for determining a score from those factors, a second methodology that uses a financial factor so that the result is an expression in pecuniary terms, and other factors perceived to be relevant by market participants. The value of the instrument over time may be indicative or representative of the market value of the underlying commodity. The financial instrument may also include a settlement value function. Embodiments of settlement value functions include: multiplying a hydrologic factor by a fixed dollar amount at pre-specified times to compute the final settlement price for the tradable instrument; a predetermined monetary amount conditional on the occurrence of an event or condition, which may be defined as the factor or score (based on multiple factors) being within a certain range or that it is higher or lower than a predetermined threshold over a predetermined time period; calculating the average and/or cumulative total of the score or factor over a fixed time interval, and multiplying this derived score or factor by a specific monetary amount; calculating a cumulative total for the water availability score or factor conditional on the score reaching a pre-specified threshold over a predefined time period and multiplying that by a specific monetary amount; or summing a discrete, binary indicator if the score or factor was higher or lower than a particular threshold and multiplying this by a pecuniary amount. In another embodiment where an instrument specifies delivery of a resource other than money, application of a financial factor may not be part of the settlement value function. In such a case, a quantity of the resource may be determined according to the specification of the financial instrument. It may be a stated amount or an amount determined with reference to the value of the score.

The present method preferably includes a process that allows participants to trade and maintain positions in an instrument by depositing less than the full value of the instrument (“margin”). The accounts of market participants could be periodically marked-to-market, so for example, if the market price of the instrument rises so that buyers, or entities holding “long” positions, may be given a credit to their account, while sellers, or those holding “short” positions, may be given a daily debit. On the other hand, if the market price of a contract falls, entities holding “long” positions may be given a debit, and those holding “short” positions may be given a credit. In one embodiment where participants are allowed to trade on margin, daily price changes might require that a buyer or seller make deposits to a margin account to maintain a certain level of money relative to the marked-to-market valuation.

The nature of the traded financial instrument may require payment by one party to a transaction, and receipt of money by another party, contingent on the achieving a specified water supply quantity on the date of the contract expiration. The traded instrument is preferably in electronic form. The parties may enter into the transaction because each may have a different opinion as to the likelihood of the future occurrence of the particular event or condition or expect to experience different effects to the extent the event or condition occurs. Economically interested parties can use an appropriately designed instrument as a financial hedge such that the receipt of a sum of money helps reduce the net economic impact created to the extent an event or condition occurs.

Preferably, the method also includes assigning an expiration date for the financial instrument to facilitate trading and risk transfer within specified time periods. The expiration date can be based on a specified future date or passage of time, wherein the instruments are available for trading during periods of weeks, months or years. It is also possible to have separate instruments which cover one of a sequence of future periods so that the instruments could be used in connection with risks that begin and end at certain points in time. In a preferred embodiment, the instrument may include a spot contract, forward contract, futures contact, swap contract, options contract or other derivative instrument.

In one embodiment, the established financial instrument may be a processor-readable medium for allocating a risk of a water shortage, including: a score calculated from one or more types of hydrological factors as disclosed herein; a settlement value function; and a settlement date. As noted above, the processor-readable medium further comprises instructions that are executed by a processor to perform actions. The actions may include transferring on the settlement date, an amount of cash or other resources to a buyer or seller of the instrument based on the settlement value function that is specified to take place to the extent an event or condition occurs.

At step 506, the financial instrument may be traded. The financial instrument may be traded on an internet-based electronic exchange. In one embodiment, the financial instrument may be traded by financial instrument trading manager 708 of FIG. 7. A trade may be entered by a party, for example, client device 731. The offer for sale of an instrument or bid for the purchase of an instrument may be provided by the trading manager 708 over a network, on an electronic trading board, or the like. Another trading participant may use a client device such as client device 730 to complete the trade (e.g., matching a bid and offer). In one embodiment, the method may include fostering, through the interaction of supply and demand in an organized market mechanism, discovery of prices for the financial instrument through trades conducted on a publicly accessible platform. In one embodiment, the bid and/or offer prices for the cash commodity may be based on the discovered price(s). Monitoring the price during a trading day may also be performed.

At step 508, water-related factor data is measured periodically or may be obtained from a source, including a website and/or reports. In one embodiment, the information may be determined by an authoritative body, agency, governmental entity, or the like. The water-related factor data may be provided.

At step 509, a score is calculated based on the one or more measured factors.

At step 510, factor data represented by the score are converted into monetary value (e.g., U.S. dollars) according to the financial instrument specification.

At step 512, a pre-expiration price for the financial instrument that is determined by buyers and sellers who post bids and offers, and/or execute trades in the instrument during a trading day. Buyers and sellers would formulate bids and offers based on the score calculated at that time and adjusted pursuant to such buyer's or seller's view of what the value would be at settlement. For example, a participant that thought the available water supply would decrease and that the value of the instrument would increase in the future, might therefore post an offer to sell an instrument at a price higher than the value produced by the score alone.

The instrument expires at step 514. At step 516, on the settlement date the instrument expires and the converted and/or calculated monetary value is used as a final settlement price in a cash-settled financial instrument. At step 518, an amount of money based on the final settlement value may be paid by one party participating in a trade of the financial instrument, and an amount of money based on the final settlement value is received by another party. In one embodiment, the payment may be configured based on payment instructions for settlement based on the magnitude of the factor or score for water availability. In one embodiment, a financial instrument trading manager 708 of FIG. 7 may initiate a funds transfer request from an account (e.g., bank account) of one participant trading the instrument, to accounts of financial intermediaries, and then to another participant's account.

By way of an example of a methodology by which a score might be used to calculate the value of a financial instrument, in one embodiment, the calculation of the score might be equal to (−1)*(stream flow expressed in thousands of gallons per minute)+(2)*(height of water in a reservoir measured in feet). Relevant factors could be measured or obtained from an authoritative source for a specific geographic area. The score may be multiplied by a financial factor to express the score in pecuniary terms (e.g., multiply the score by $50). During the period prior to expiration, market participants could formulate bids and offers for such an instrument reflecting their view on what such instrument would be worth at future settlement, thereby determining a current market value. On the settlement date a settlement value might be determined based on the value of the score determined on the settlement date. It might be multiplied by the financial factor. The resulting value would be the basis for the amount of money received in settlement by buyers or sellers of the instrument.

Accordingly, an insurance-like process may be established that provides compensation to a hedging party to a risk-transfer transaction. To the extent the event or condition occurs, the hedging party can use the funds received to mitigate the harm or burden it faces as a result of the economic impacts due to water shortages. In another embodiment, the entity purchasing the financial instrument may receive a right to receive, own, or otherwise control the commodity underlying the established financial instrument if a certain event or condition occurs.

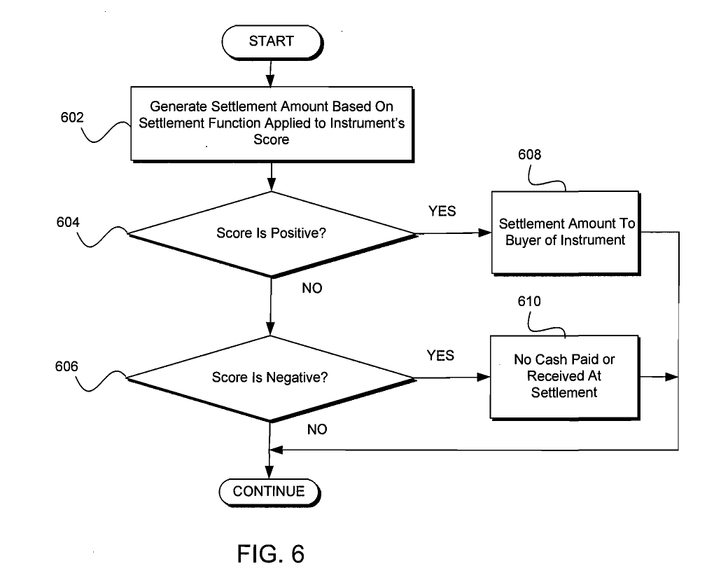

FIG. 6 shows a logical flow diagram for making a cash payment on settlement date according to one embodiment. The process of FIG. 6 may be performed by server device 702 and/or client devices 730-731 of FIG. 7.

At step 602, a settlement amount is generated based on the settlement value function applied to instrument's factor or score. In one embodiment, the settlement amount may be determined based on at least one of: the factor or score on the settlement date; a change of the factor or score; an average change of a factor over a time period; a value of the factor or score on the settlement date less a threshold value configured in the financial instrument; a weighted sum of a weight function applied to each portion of the factor of score, if the factor or score has more than one portion; or the like.

At determination step 604, it is determined whether the settlement amount is positive. If the settlement amount is positive, processing continues to step 608 and the buyer of the instrument would receive a payment at settlement. Otherwise, processing continues to step 606. In one embodiment, the settlement amount may be transferred based on a payment instruction for settling the financial instrument, wherein the instruction is configured in the financial instrument. In one embodiment, the amount may be transferred from the seller. In another embodiment, amounts are paid to a third-party clearinghouse that pays participants who are entitled to a settlement payment. The clearinghouse may act as an intermediary that receives payments from and makes payments to multiple parties who have bought or sold the same type of instrument.

In another embodiment, the settlement of the instrument could involve the delivery of a physical commodity described in the specification for the instrument. In such a case, a seller of the instrument that had not transferred its interest or made an offsetting trade would be required to deliver a specified amount of the underlying commodity, of a certain condition and grade, to a particular location. The buyer of the instrument would be required to make a payment in the amount described in the specification for the instrument.

At determination step 606, it is determined whether the settlement amount is zero or negative. If the settlement amount is zero or negative, processing continues to step 610. Otherwise, processing continues to a calling process for further processing. At step 610, the instrument settles with no payment to or from either party. In another embodiment, a cash settlement amount could be transferred to a participant that sold the instrument. In any event, if the instrument is purchased by deposit of less than the full value of the instrument (on “margin”), settlement would also require that the purchaser fully fund the purchase price in addition to any other obligations it might have at settlement. In one embodiment, these transfers can be made to or from an account that is established for the buyer or seller of the financial instrument.

FIG. 7 shows a method and system for allocating a risk of a water shortage. In one embodiment, the system of FIG. 7 provides a market-based contractual mechanism that allows the transfer of future water shortage risks in particular geographic regions from those who face economic risk from such events or conditions, to those financial and investor agents that are willing to accept such risks. The contractual financial instruments may be traded on an organized exchange, using for example, financial instrument trading component 708. In other embodiments, the instruments may also be traded in other markets such as through over-the-counter trades or private party transactions, as transactions in products offered by banking and investment institutions.

The organized exchange can include a system for facilitating trading between parties. The system can include a trading host or platform, such as server device 702, a registry, and a guarantee mechanism. The system can be coupled to a network, such as the Internet or any other public or private network or connections of computing devices.

The trading platform 702 includes an electronic mechanism for hosting market trading that provides participants with a central location that facilitates trading, and publicly reveals price information. The trading platform reduces the cost of locating trading counterparties and finalizing trades, important attributes of an efficient market. In one embodiment, parties using client devices 730-731 may receive information about tradable instruments, may send buy or sell orders for the instruments to sever device 702, or the like.

The traded financial instruments may be established using environmental risk factor manager 704. Traded financial instruments, which preferably are in the form of futures or options contracts, may also take the form of spot contracts, forward contracts, swap contracts, swaptions, mutual funds, bonds, and all such related contracts that have a price, return, dividend, equity instruments and other derivative instruments, or other financial performance that is based on water supply quantity in a particular geographic region.

In one embodiment, margin maintenance manager 706 may maintain a margin amount for at least one account for at least one trading participant. In one embodiment, the margin amount for an account of a party participating in a trade of the financial instrument may be determined based in part on a value of the factor or score, and require that a participant deposit additional money to its account or may allow a participant to withdraw money from its account based on the settlement value function applied to the score as determined from day to day.

To further illustrate, consider the following example whereby an agricultural district is dependent upon a particular river for irrigation. If the river flow becomes low in a particular spring, the farmers will not have sufficient water to irrigate their crops and are exposed to economic loss. The agriculture district could utilize a futures contract as a hedge against this situation. Under one possibility, suppose that a financial instrument contract was structured so that the purchaser received $100 per contract if the flow of the river decreased below a specified threshold on a particular date. The district may have a forecast based on what they hypothesize the river flow to be. This may be based on climate variables or water level readings. A factor used to determine the final settlement price could be measured by a government agency and reported on a website maintained by that government agency on a periodic basis. Thus, market participants would be able to track the factor periodically over this time period and form expectations of the future value of the score, the market value from time to time, and at the final settlement date.

Suppose that the agricultural district purchases one contract for $20. The agricultural company has taken a “long” position in the contract as a means of offsetting the negative economic consequence of a water shortage. In the event that the water supply declined below the pre-specified threshold, the entity would receive $100. After the cost of the contract was deducted, the district would have received a net of $80 to compensate for the shortage through the purchase of one contract.

Note that any of the functions, method steps, or processes of the invention can be performed by one or more hardware or software devices, processes, or other entities. These entities can reside in the same location or can reside remotely as, for example, entities interconnected by a digital network such as the Internet, a local area network (LAN), campus or home network, standalone system, etc. Although functions may have been described as occurring simultaneously, immediately or sequentially, other embodiments may perform the functions, steps or processes in a different order, or at substantially different times with respect to execution of other functions, steps, or processes.

It will be understood that the systems and software described herein include, either explicitly or implicitly, software implemented on computers or other appropriate hardware, including such other intelligent data processing devices having processors, data storage means, and the ability to support an operating system, with or without user interfaces, for example, file servers, as may be useful in implementing this invention.

Preferred embodiments of the invention provide program product, which can cause a general-purpose computer to operate as a special-purpose computer, in accordance with the disclosure herein. Such program product implemented on a general-purpose computer, in accordance with the disclosure herein. Such program product implemented on a general-purpose computer constitutes an electronic customizing machine that can interact with a magnetically or optically cooperative computer-based input device enabling the computer to be customized as a special purpose computer, according to the contents of the software. To cause a computer to operate in such a customized, special-purpose mode, the software can be installed by a user or some other person, and will usually interact efficiently with the device on which it resides to provide the desired special-purpose functions or qualities, and/or after the selection of configuration parameters which are often unique to the operating system(s) used by the computer. When so configured, the special-purpose computer device has an enhanced value, especially to the professional users for whom it may be intended.

It is to be understood that the terms “device”, “computer”, “server”, “data storage means,” as well as cognate terms, denote either physical or logical instances of those entities. For instance, a computer, data storage means and server may be implemented as separate physical entities or as one physical entity performing logically separate functions. Similarly two servers may be implemented as separate physical entities or as one physical entity performing logically separate functions. Also, a computer may be envisaged as a “terminal” which will be understood to include mobile devices (e.g. mobile phones or PDAs) as well as stationary computers.

What is claimed is:

1. A computer-implemented method for allocating a risk of the occurrence of an event or condition which comprises establishing:
a computer-readable financial instrument based on a score, determined from one or more factors that indicate the extent to which the event or condition has occurred, used to determine a value for the financial instrument;
a settlement value function; and
a settlement date, wherein the financial instrument is configured to transfer on the settlement date, a settlement involving a cash payment or transfer of other resources based on the extent to which the event or condition has occurred.

2. The method of claim 1, wherein the event or condition further comprises a type of event or condition that is of interest to users in a geographic area or with certain interests in common and wherein the factors are weighted to create an accurate indicator of the extent to which an event or condition has occurred.

3. The method of claim 1, which further comprises:
establishing one or more factors that indicate the extent to which the event or condition has occurred; and
providing a trade of the financial instrument;
wherein providing the trade of the financial instrument further comprises participants receiving a value of the factors or scores.

4. The method of claim 3, which further comprises:
determining, in response to the received value of factors or scores, a price for the trade based on bids and offers for the financial instrument.

5. The method of claim 4, which further comprises:
determining a trade price that is by matching bids and offers representative of the market value of the instrument prior to expiration of the instrument.

6. The method of claim 1, wherein the score is converted to an amount of money using a financial factor, or to a quantity of a physical resource based on the score or a value stated in a specification of the instrument.

7. The method of claim 1, which further comprises:
determining the settlement amount at an expiration of the financial instrument based on at least one of:
the score calculated from the one or more factors;
a change of the score from one point in time to another point in time;
an average change of the score over a time period;
a value of the score on the settlement date less a threshold value configured in the financial instrument;
when the score has more than one portion, a weighted sum of the score portions, or
determining the settlement amount by whether the score is zero or within ranges of positive or negative values.

8. The method of claim 1, wherein the establishing further comprises:
providing an interface to present the financial instrument to a user with an economic interest in the occurrence of the event or condition.

9. The method of claim 1, wherein the financial instrument has a market value that changes if there is a change of the score.

10. The method of claim 1, further comprising:
enabling market participants to undertake trades of the financial instrument by depositing a margin amount less than the full price of the instrument, and the margin amount required to be kept on deposit changes based on the value of the score as calculated from time to time, so that participants may periodically be required to make further deposits of margin or be allowed to withdraw at least a portion of the margin amount based on variations in the score.

11. The method of claim 1, wherein the financial instrument is at least one of a spot contract, forward contract, futures contract, options contract, swap contract or other derivative instrument.

12. The method of claim 1, which further comprises:
transferring a cash payment or other resources based on an instruction for settling the financial instrument, wherein the instruction is specified in a contract specification or otherwise configured in the financial instrument.

13. A system for allocating a risk of the occurrence of an event or condition, comprising at least one processor which is configured to perform the steps of claim 1.

14. A computer-implemented method for providing money or resources to an entity to compensate for a shortage of water necessary for an operation of the entity, which comprises:
establishing a financial instrument based on a water availability score that is calculated from one or more types of hydrological factors, a settlement value function, and a settlement date;
receiving a right to the established financial instrument; and
receiving the compensation based on a settlement value function that involves applying a pecuniary factor to the score on the settlement date.

15. The method of claim 14, wherein the score reflects available water supply that is calculated from one or more types of hydrological factors.

16. The method of claim 14, wherein the types of hydrological factors used to determine a score comprise:
an aquifer level,
a snow-pack level,
a stream-flow measurement,
an above-ground body of water level,
a weather measure,
a predictive weather measure,
a climate oscillation in a climate measure,
a precipitation level, or
such other factors that indicate that water is plentiful or scarce.

17. A processor-readable medium for allocating a risk of a water shortage, comprising:
a water availability score that is calculated from one or more types of hydrological factors;
a settlement value function; and
a settlement date,
wherein the processor-readable medium further comprises instructions that are executed by a processor to perform actions comprising:
transferring, on the settlement date, an amount of cash or other resources in settlement to a buyer or seller of a financial instrument based on the settlement value function using the score.

18. The processor-readable medium of claim 17, wherein the actions further comprises:
determining a settlement amount for the financial instrument based on at least one of:
the score calculated from one or more factors;
a change of the score from one point in time to another;
an average change of the score over a time period;
a value of the score on the settlement date less a threshold value configured in the financial instrument;
when the score has more than one portion, a weighted sum of the score portions, or
determining the settlement amount by whether the score is zero or within ranges of positive or negative values.

19. The processor readable medium of claim 17, wherein the score has more than one portion and the actions further comprise:
determining a settlement amount for the financial instrument based on a weighted sum of the score portions.

20. A computer-implemented method for creating an event-linked derivative financial instrument, which comprises:
identifying an event or condition that is of interest to a type of entity;
identifying a factor that is indicative of the extent to which an event or condition has occurred;
determining a methodology that derives a score from at least one factor that indicates the extent to which the event or condition has occurred;
determining another methodology that determines an amount of money or resources to be delivered at settlement of a financial instrument based on the score;
creating a settlement value function for the financial instrument based on the methodologies; and
providing the financial instrument for trading.
